(19) United States
(12) Patent Application Publication
(10) Pub. No.: US 2011/0258226 A1
(43) Pub. Date: Oct. 20, 2011

(54) METHOD AND SYSTEM FOR OPERATING IDENTIFIER MANAGEMENT

(76) Inventors: Rainer Schatzmayr, Bonn (DE); Holger Weinhardt, Bad Honnef (DE)

(21) Appl. No.: 13/132,154

(22) PCT Filed: Nov. 17, 2009
(86) PCT No.: PCT/EP2009/008181

§ 371 Date: Jul. 5, 2011

(30) Foreign Application Priority Data
Dec. 4, 2008 (DE) 10 2008 060 220.5

(51) Int. Cl. G06F 17/30

(52) U.S. Cl. 707/769; 707/E17.014

(57) ABSTRACT

The invention relates to a system and a method for operating identifier management (AB 1, AB 2) in which at least one user subscriber number and a plurality of identifiers and/or pointers to identifiers can be stored, which identify the user within a communications service of a provider and which can be assigned to the subscriber number, an inquiry being made to the identifier management with transfer of the subscriber number as a parameter and the identifier management checking whether the subscriber number is assigned one identifier or several identifiers, and the identifier or identifiers being returned as a response when there is assignment.

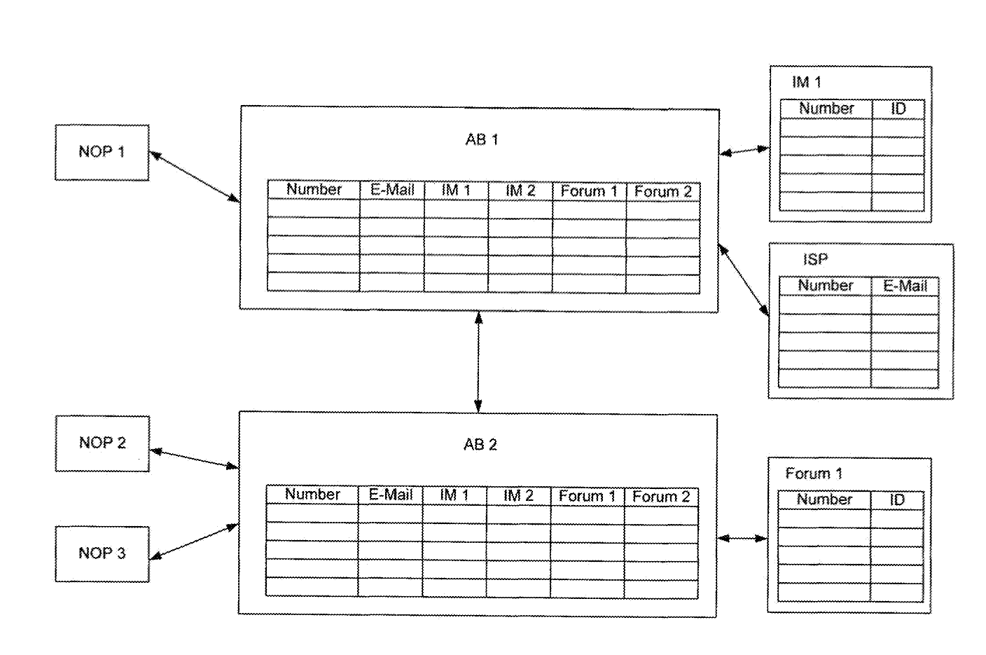

The invention relates to a method and a system for operating identifier management in which at least one user subscriber number and a plurality of identifiers and pointers to identifiers can be stored, which identify the user within a communications service of a provider and which are assigned to the subscriber number.

Customers of network operators or other service providers such as Internet providers, Email providers, instant messaging providers, operators of Internet forums or operators of Internet platforms on which a group of individuals with common interests (so-called communities) can exchange with one another have a plurality of addresses and identities for use of these electronic communications services. Generally those addresses and identities which all together constitute identifiers are without reference to one another so that the holders of these addresses and identities must disclose all of these identifiers to their communications partners so that they can be found and addressed within the corresponding electronic communications services.

For example, the customer of a cellular network operator has a subscriber number which has been assigned to him by the cellular network operator. The same user can likewise have a private E-mail address which is made available to him by an Internet provider or an E-mail provider. In addition, the same user can have an identity within an instant messaging community, the identity constituting an identifier which is made available by the company which operates the Internet platform on which the community is organized and exchanges. The result of this host of identifiers is the following: when a communication participant would like to communicate his contact addresses to a communications partner, he must disclose to him his telephone number, his E-mail address and his diverse identities which he has within the framework of his activities in instant massaging communities. Here it can be stated that this situation becomes more complex, the more Internet users enlist in Internet-based forums on certain topics, participate in Web 2.0 communities or use other communications services since most of these forums and communities generate their own contact addresses or identities for the respective user.

The primary identifier which is used by a cellular operator is an E.164 format-based telephone number which within the cellular network constitutes the address of the cellular subscriber. The subscriber number is the confidential identity of the subscriber which has already been established in the market for his identification. Each telephone number is one-time among the different network operators. Cellular subscriber numbers are generally viewed by the telecommunications service users as their personal subscriber numbers which are assigned to them personally as their “own” subscriber number. Accordingly a subscriber number, especially a cellular subscriber number, constitutes the primary identifier of the telecommunications subscriber while other identifiers such as for example E-mail addresses, instant messaging addresses, forum names (alias) or community identities are represented solely as additional forms of addressing for the service user whose telephone number is known. These additional identifiers in addition to a cellular subscriber number are associated with a specific communications service. They represent the communications service user within this communications service. Examples of this are “a private E-mail address for family matters”, “an identity for an online, i.e. Internet-based, community for the publication of photographs”, or “an identifier for an online community for preparation of a professional network”.

It is currently prior art, in the address books of communications terminals, such as for example mobiles handsets or computers, to provide input fields in which different types of identifiers can be input, in addition to names, telephone numbers and geographic addresses of individuals. According to prior art modern electronic address books are likewise able to store Email addresses and/or instant messaging identities. Moreover these address books are developing such that they are also able to store additional identifiers, including those which are used by online communities.

E-mail providers, instant messaging communities, Internet forums and Web 2.0 communities have their own internal and user-specific address book databases. These address books generally contain not only contacts of friends or known communications partners, whom the user has selected within the communications service, but generally also comprise additional fields for storage of names, telephone numbers and geographical addresses of the respective user. These different address books are not synchronized to one another so that each time a user changes an identifier in a communications service, for example his E-mail address, it is necessary that the user notifies all of his contacts or his communications partners about this change in order to remain accessible in the communications service. This is especially tedious and more expensive, the more communications partners a user has within the communications service.

It is therefore the object of this invention to propose a method and a system for operating identifier management by means of which in a simple and user-friendly manner all communications partners within a communications service, and blanketing the service within other communications services which the user is using, are notified about the change of the user identifier.

This object is achieved by a method as claimed in claim 1 and by a system as claimed in claim 8. Advantageous developments of the invention are formulated in the respective dependent claims.

As claimed in the invention, a method for operating identifier management is proposed in which at least one subscriber number of a user and a plurality of identifiers and/or pointers to identifiers can be stored which identify the user within a communications service of a provider and which can be assigned to the subscriber number, an inquiry being made to the identifier management with transfer of the subscriber number as a parameter and the identifier management checking whether the subscriber number is assigned one identifier or several identifiers, and the identifier or identifiers being returned as a response when there is one assignment or several assignments.

With this measure automatic synchronization of the different address books within the most varied communications services of the individual service providers can be achieved, so that the user of a communications service need not disclose his altered identifier in a specific communications service to each communications partner individually. For the purposes of the invention identifiers are all types of identification of a subscriber within a communications service, especially addresses such as E-mail addresses or instant messenger addresses, or identities such as user names, aliases or other identifiers. Telephone numbers such as fixed network subscriber numbers or cellular subscriber numbers are addresses within a communications network and thus identifiers in the sense of the invention, and a cellular subscriber number such as described above can be regarded as a primary identifier.

The basic idea of identifier management which is also called “address broker” below is to make available a central entity which acts as a mediator, broker or agent and which undertakes assignment to or registration and management of different addresses or identities to subscriber numbers. The address broker is able to receive inquiries from communications services which are linked to a specific subscriber number and as a response send back at least one identifier which is registered in the identifier management for this specific subscriber number.

A user profile within a communications service which contains entries of identifiers to other communications services including the subscriber number of the user can always be kept updated by an inquiry to the identifier management since the identifier management sends back the identifiers of the user of other communications services, which identifiers are assigned to the subscriber number, and which then can be entered at the corresponding locations of the user profile of the interrogating communications service, at least to the extent the identifiers are available in the identifier management. The relationship of the subscriber number of the user to one identifier or to several identifiers can be registered by the user himself in the identifier management and can be exchanged on the basis of the corresponding agreements between the identifier management provider and the service providers about the exchange of data.

The pointer to an identifier is an address under which one identifier can be found. The address thus refers to the storage site of the identifier which is generally at the service provider itself As claimed in the invention the identifier management can query an address to which a pointer assigned to the subscriber number refers. The pointer can be for example an Internet address of the service provider. This has advantages for data security. The personal data of a user remain at the service provider who has assigned the identifier of the user or is at least managing it, to the extent the user has been assigned the identifier itself. Data transmission takes place only when the identifier management queries the specific identifier of the user. Uncontrolled dissemination of the identifier by queries of the identifier administration by unauthorized parties can thus be prevented.

In checking whether the subscriber number is assigned one identifier or several identifiers, can therefore take place in that the destination address of a pointer stored in the identifier administration at the subscriber number is queried for the identifier, the queried service provider transmits the identifier to the identifier management and the latter then sends back the identifier as an answer [sic].

As claimed in the invention, in the identifier management new service providers can be registered to store the identifiers of their users or pointers to these identifiers in the identifier management. For this storage of new identifiers and/or pointers to these identifiers of a service provider which is being newly registered in the identifier management, the identifier management for each subscriber number can apply a placeholder for the entry of an identifier or pointer assigned to the subscriber numbers at this service provider. If the identifier management is advantageously structured in the form of a database, this means that in each data set which consists of at least one subscriber number as the primary identifier a new parameter is generated in which as the parameter value that identifier can be entered which the user of the subscriber number has at the newly registered service provider. If the holder of a subscriber number for the service provider (still) has no identifier, the parameter value of the new parameter remains accordingly unoccupied.

In one advantageous development of the invention, the service provider after registration at the identifier management can search the user profiles of his user database for subscriber numbers and transmit these subscriber numbers together with the identifiers or pointers to the latter assigned to them to the identifier management for storage and central management in the latter. The identifier management can receive the individual subscriber numbers together with the identifiers or pointers assigned to them and check each subscriber number for whether the subscriber number is stored in it. If the identifier management finds the subscriber number, it can fill the new parameter with the identifier or a pointer to the identifier, i.e. enter the identifier or the pointer in place of the placeholder of the data set assigned to the subscriber number as the primary identifier.

If a subscriber number which is unknown to the identifier management is transmitted by the service provider, the inquiry or the identifier transmitted for storage or the pointer together with the subscriber number can be relayed to a second identifier management which is connected to the identifier management and to which the subscriber number can be known for interrogation of it or storage in it. This cascade principle can be continued even if the second identifier management does not contain the subscriber number so that the inquiry is relayed to a third identifier management.

As claimed in the invention the second identifier management or in another configuration of the method a possible third identifier management can check whether the subscriber number is stored in it and whether the subscriber number is assigned one or more identifiers, and the identifier or identifiers are returned as an answer when there is assignment. The assignment can also be checked again here by the destination address of the pointer stored in the identifier management for the subscriber number being interrogated for the identifier, the interrogated service provider transmitting the identifier to the identifier management and the latter then returning the identifier as the answer.

Inquirers in the sense of the invention can be service providers who have registered at the identifier management, i.e. are entitled to inquire. Furthermore, an inquiry can also take place by another identifier management which itself has received an inquiry, and which however does not contain the transferred subscriber number in its database. An inquiry from a telephone network operator which makes available the subscriber numbers for the identifier management can also take place.

The system as claimed in the invention for operating an identifier management in which at least one subscriber number of a user and a host of identifiers and/or pointers to identifiers can be stored which identify the user within a communications service or a provider and which can be assigned to the subscriber number, comprises a server for accepting inquires and sending answers, a database which contains at least one subscriber number and the identifiers and/or pointers to identifiers and which is connected to the server, interfaces to several service providers via which the inquiries and answers are sent, and an agent which is running on the server and which is set up to accept an inquiry with transfer of the subscriber number as the parameter, to interrogate the database whether the subscriber number is assigned one or more identifiers or one or more pointers, and to return the identifier or identifiers as an answer when there is assignment. This system can be used for executing the method as claimed in the invention.

The system can preferably have an interface to a communications network operator which prepares the subscriber numbers for the identifier management. The latter can keep the subscriber numbers of the database updated via the interface, especially can add new subscriber numbers or replace subscriber numbers which are no longer valid.

Preferably the system can furthermore have an interface to another identifier management. This is especially useful when the identifier management is being operated by a certain communications network operator and the database holds only those subscriber numbers which are assigned to the line subscriber within the communications network. It can therefore be provided that another network operator which likewise makes available line identifiers in the form of subscriber numbers for his subscriber lines operates his own identifier management to which the first identifier management has a corresponding interface. Via this interface an inquiry directed to the first identifier management can be forwarded if this identifier management cannot find the transferred subscriber number in its database. The second identifier management would then accept the inquiry and interrogate its corresponding database whether one identifier or several identifiers are assigned to the subscriber number and would return the identifier or identifiers as an answer either to the first identifier management or if the second identifier management likewise has an interface to the inquiring service provider, directly to the latter when there is assignment.

The invention is explained below using illustrated embodiments and the attached figures.

A service provider for the purposes of the invention is any provider or operator of cable-linked, wireless-based, Internet-based (online) and other communications services and platforms, especially E-mail services, instant messaging services, Internet-based forums and Web 2.0 communities. Furthermore a network operator is defined as a company or organization which operates a telecommunications network and offers telecommunications services to its subscribers. Subscribers, users or customers are individual end users who claim these services.

The identifier management which is called an “address broker” below can be operated as a central system with interfaces to several service providers, alternatively it can be made as a distributed system within which two or more address brokers are connected to one another.

The address broker can be connected over an interface to one or more network operators which make available the subscriber numbers of their respective customers to the address broker.

Furthermore the address broker can be connected over interfaces to several service providers which in turn disclose to the address broker or keep retrievable the identifiers of their respective customers assigned to the subscriber numbers.

The address broker thus manages the assignment of addresses from one or more network operators to those of one or more service providers. For example the address broker can return an answer in the form of an E-mail address if it comprises an interface to an E-mail service provider. Furthermore it can return an answer in the form of an instant messaging address or identity if it comprises an interface to an instant messaging service provider. Furthermore the address broker can also return an answer in the form of any identity from a forum or a community if it has a corresponding interface to one or more Internet-based forums or Web 2.0 communities.

The specific communications service is registered at the address broker by a service provider agreeing to share his information about the corresponding customer identities with the company operating the address broker or to make it available to the company. This can take place by the service provider notifying his customers that when he recognizes a subscriber number in a certain user profile of his customer, he always makes available the customer identity assigned to the subscriber number in the address broker for inquiries relating to subscriber numbers. Security mechanisms which prevent misuse of the data which have been made available can be made available both by the service provider and also by the company operating the address broker.

The address broker is described below using individual examples.

A user A at an E-mail provider has the E-mail address A@company.com. At the E-mail provider he has a user profile which comprises his private telephone number +1234567890. After user A has provided his profile with this telephone number, the E-mail provider registers his E-mail service at the address broker with the information: “For subscriber number +1234567890 a valid Email address is A@company.com”.

Different communications services from different providers can be registered in this way at the address broker. The following table represents a database of the identifier management after four service providers have registered at the identifier management and have stored the corresponding user recognitions from the profiles of their users in the address broker. The database of the address broker comprises individual data sets with a subscriber number, an E-mail address, an identity at a first instant messaging provider, an identity at a second instant messaging provider, and an identity of a first Internet-based forum.

| Subscriber | | | | |
|---|---|---|---|---|
| Number | E-mail | IM 1 ID | IM 2 ID | Forum 1 ID |
| +1234567890 | A@company.com | | | |
| +1111111111 | | Superman8 | Shazaa | |
| +2222222222 | me@myself.com | | | Bodo |
| +3333333333 | | | Malcom | |

The first data set according to the above described example comprises the subscriber number +1234567890 to which is assigned only the E-mail address “A@company.com”. A second data set with the sample subscriber number +1111111111 is not the identifier of the registered Email provider, i.e. an E-mail address is not assigned, but the holder of this subscriber number uses one identity at the first and one identity at the second instant messaging provider. One E-mail address “me@myself.com” is assigned to the third data set with the subscriber number +2222222222 at the E-mail provider and one identify “Bodo” at an Internet-based forum. Finally, in a fourth data set with subscriber number +3333333333 it is assigned solely an identity “Malcom” at the second instant messaging provider.

Alternatively to a specific identifier, the database can contain pointers to a specific identifier, one pointer to an identifier and thus indirectly the identifier itself to which the pointer refers being assigned to a certain subscriber number. One pointer can then be used when the service provider would not like to disclose the identity of one or all of his customers to the address broker, but instead makes available an interface by means of which the address broker can make an inquiry to the service provider in order to interrogate the identifier. In this case the address broker can contain the following sample entries:

| Subscriber | | | | |
|---|---|---|---|---|
| number | E-mail | IM 1 ID | IM 2 ID | Forum 1 ID |
| +1234567890 | A@company.com | | | |
| +1111111111 | | Superman8 | Check under | |
| | | | IM2.com | |
| +2222222222 | check under | | | Bodo |
| | myself.com | | | |
| +3333333333 | | | Check under | |
| | | | IM2.com | |

In this case, the entries of the database can contain pointers such as for example “pruefe@xxx” or “check@xxx”. If a subscriber number is assigned such a pointer, the address broker generates a corresponding inquiry for the specific identifier at the corresponding service provider or at the address to which the pointer refers. Preferably the pointer can point to an Internet address of the corresponding service provider. The service provider then returns the identifier, whereupon the address broker can transfer this identifier to the inquirer as an answer.

In one special version of the invention all entries of a certain service provider for subscriber numbers can be formed by pointers so that inquires directed to the address broker for a certain telephone number are always relayed to the corresponding service provider to which the pointers refer. This method can be to used especially when it is unknown to the address broker for which subscriber number he is to make the corresponding inquiry to the service provider, i.e. for which subscriber number there is an identifier at this service provider. This is illustrated by the following table for the service provider IM 2.

| Subscriber | | | | Forum 1 |
|---|---|---|---|---|
| number | E-mail | IM 1 ID | IM 2 ID | ID |
| +1234567890 | A@company.com | | Check under | |
| | | | IM2.com | |
| +1111111111 | | Superman8 | Check under | |
| | | | IM2.com | |
| +2222222222 | Check under | | Check under Bodo | |
| | myself.com | | IM2.com | |
| +3333333333 | | | Check under | |
| | | | IM2.com | |

The address broker can be interrogated by a network operator, for example a telephone network operator. The telephone network operator makes available telephone numbers and receives from the address broker as an answer to the inquiry all or some of the identifiers which are linked to the subscriber numbers which have been made available. The number of identifiers which are made available in an answer can be limited to those subscriber numbers for which there is business consent.

The address broker can be interrogated either by the network operator, such as for example a telephone network operator, by a service provider or by another address broker. In certain applications it can be the case that the address broker does not have an entry of a certain subscriber number or a certain identifier, but has information about more precisely an interface to another address broker which may be managing the required information. The address broker can thus relay a corresponding inquiry to the second address broker, a cascaded arrangement of the address brokers arising in the inquiry. In this application, in the database of the first address broker a general pointer or for a certain subscriber number a pointer to a second address broker can be set which contains the corresponding information about the identifier assigned to the subscriber number.

If the search of the address broker shows that the subscriber number transferred as the parameter is not contained in the address broker or a certain identifier to this subscriber number is not contained in the address broker, the address broker can relay the inquiry to a second address broker which then processes the inquiry, and when a corresponding assignment of an identifier or a counter to the transferred subscriber number is found an answer in the form of the inquiry is returned.

The figure shows a simplified representation of the system as claimed in the invention for operating the above described address broker. The figure shows a first address broker AB 1 which comprises a database which is shown in the form of a table. The address broker AB 1 constitutes an agent or mediator which runs on a server. The server is connected to the database containing the subscriber numbers and identifiers and/or pointers. The first address broker AB 1 comprises an interface to a first network operator NOP 1 which makes available the subscriber numbers of his customers to the first address broker AB I. Furthermore the address broker AB 1 comprises interfaces to the two service providers IM 1 and ISP. The first service provider IM 1 is an instant messaging provider which for each of its customers keeps a user profile which comprises or can contain a subscriber number and an identifier ID of the user within the instant messaging service when the user stores the subscriber number in its profile. The second service provider ISP is an Internet service provider which likewise keeps user profiles from its customers which each comprise one subscriber number and one E-mail address of the customer.

The first address broker AB 1 is connected to a second address broker AB 2 and can exchange data with it or send inquiries to it and receive them or relay inquiries to it. The second address broker AB 2 in this sample case is set up identically to the first address broker AB 1. But it has one interface each to a second network operator NOP 2 and a third network operator NOP 3 which make available the subscriber numbers of their telecommunications customers to the second address broker AB 2. The second address broker AB 2 furthermore has an interface to a service provider “forum 1” in the form of an Internet forum. This service provider also maintains from its users the user profiles which comprise the subscriber number and the identifier ID of the respective user.

If for example the E-mail address changes for a customer of the service provider ISP, the customer can input this new E-mail address either manually into the address broker AB 1 or can accordingly update the user profile kept at its service provider, whereupon the service provider undertakes a corresponding automatic update of the entry in the address broker AB 1. If the customer of the service provider ISP 1 is at the same time a customer of the service provider IM 1 and if the profile stored at it likewise comprises an E-mail address which would have to be updated, it is sufficient for updating this E- mail address if the service provider IM 1 matches his data to the address broker, its transmitting the subscriber number of the user to the address broker as a parameter. Then the address broker checks whether the subscriber number is assigned an identifier or several identifiers, especially an E-mail address, and returns the identifier or identifiers including the E-mail address as an answer to the service provider IM 1 if it finds an assignment. The matching of the data between the service providers and the address broker or brokers can take place automatically, especially at regular intervals, so that all user profiles of the users are always updated at the individual communications services. This greatly simplifies the handling of a plurality of identifiers which a user has at the diverse service providers since they need no longer be manually disclosed to all communications partners in the case of a change.

1-10. (canceled)

11. A method of operating identifier management in which at least one user subscriber number and a plurality of identifiers or pointers to identifiers can be stored that identify the user within a communications service of a provider and that can be assigned to the subscriber number, an inquiry being made to the identifier management with transfer of the subscriber number as a parameter and the identifier management checking whether the subscriber number is assigned one identifier or several identifiers, and the identifier or identifiers being to returned as a response when there is assignment, wherein the identifier management forwards the inquiry or the identifier transmitted for storage or the pointer transmitted for storage together with the subscriber number to a second identifier management when the subscriber number is not stored in the first identifier management, and that the second identifier management checks whether the subscriber number is stored in it and whether the subscriber number is assigned one or more identifiers, and the identifier or identifiers are returned as an answer when there is assignment.

12. The method defined in claim 11, wherein the identifier management interrogates the destination to which a pointer to an identifier assigned to the subscriber number refers.

13. The method defined in claim 11, wherein for storage of new identifiers or pointers to identifiers of a service provider that is being newly registered in the identifier management the identifier management for each subscriber number applies a placeholder for the entry of an identifier assigned to the subscriber number at this service provider or a pointer to this identifier.

14. The method defined in claim 13, wherein the service provider after registration at the identifier management searches his user database for subscriber numbers and transmits these subscriber numbers together with the identifiers or pointers to the latter assigned to them to the identifier management for storage in the latter.

15. The method defined in claim 14, wherein the identifier management receives the transmitted subscriber numbers together with the identifiers or pointers assigned to them and checks each subscriber number for whether it is stored in the identifier management, in the case of storage the identifier or a pointer to the identifier being entered instead of the placeholder.

16. A system for operating identifier management in which at least one user subscriber number and a plurality of identifiers or pointers to identifiers can be stored that identify the user within a communications service of a provider and that can be assigned to the subscriber number, the system comprising:
a server for accepting inquires and sending answers;
a database containing the subscriber number and the identifiers or pointers to identifiers and connected to the server;
interfaces to several service providers via which the inquiries and answers are sent;
an agent running on the server and set up to accept an inquiry with a subscriber number as the parameter, to interrogate the database whether the subscriber number is assigned one or more identifiers or one or more pointers, and to return the identifier or identifiers as an answer when there is assignment; and
an interface to another identifier management.

17. The system defined in claim 16, further comprising an interface to a communications network operator that makes available the subscriber numbers tier identifier management.

18. The method defined in claim 11, wherein the inquiry is made by a communication service that contains entries of identifiers to other communications services including the subscriber number of the user, and wherein the identifier management sends back the identifiers of the user of the other communications services that then are entered at the corresponding locations of the user profile of the interrogating communications service, at least to the extent the identifiers are available in the identifier management.
